(19) United States
(12) Patent Application Publication
(10) Pub. No.: US 2010/0038226 A1
(43) Pub. Date: Feb. 18, 2010

(54) ILLUMINATED KEYBOARD MODULE

(76) Inventor: Hung Lin, Keelung City (TW)

Correspondence Address: APEX JURIS, PLLC, 12733 LAKE CITY WAY NORTHEAST, SEATTLE, WA, 98125, US

(21) Appl. No.: 12/193,549

(22) Filed: Aug. 18, 2008

(51) Int. Cl. H01H 13/70; F21V 21/00

(52) U.S. Cl. 200/314; 362/249.09

(57) ABSTRACT

An illuminated keyboard module has a base, a film circuit membrane, a illuminator membrane, multiple supporting frames, multiple keys and multiple illuminator. The film circuit membrane is attached onto the base. The illuminator membrane is attached onto the film circuit membrane and has multiple wires. The multiple supporting frames are attached onto the illuminator membrane and are connected to the base. Each key is attached onto the top of a supporting frame and has a light permitting portion. Each illuminator is attached to the illuminator membrane under a key and electrically connected to the wires. The illuminator irradiates lights going through the light permitting portions of one key to provide satisfying illuminating effect.

### BACKGROUND OF THE INVENTION

1. Field of the Invention

The present invention relates to an illuminated keyboard module, especially to an illuminated keyboard module having multiple keys wherein an illuminator is located under each of the keys.

2. Description of the Prior Art

With reference to FIGS. 4, a conventional illuminated keyboard (for example: Taiwan Utility Model No. M324816) comprises a base (20), a film circuit membrane (21), a illuminator membrane (22), multiple supporting frames (23), multiple keys (24) and multiple lighting guiding plates (25).

The base (20) has base connectors (27).

The film circuit membrane (21) is attached onto the base (20).

The illuminator membrane (22) is attached onto the film circuit membrane (21) and has multiple wires (26) and multiple domes (221) each being located between the base connectors (27).

The supporting frames (23) are structured as pairs of scissors and are connected to the base connectors (27) and has a top.

Each key (24) is attached onto the top of a supporting frame (23), is located above a dome (221) and has a bottom and a light permitting portion forming a symbol or a character.

The light guiding plate (25) is attached beneath the base (20) has a side and a light source (26) attached to the side.

A light radiated from the light source (26) of the conventional illuminated keyboard is guided upward by the light guiding plate (25). The conventional keyboard may further has a reflecting plate (28) being attached beneath the light guiding plate (25) and being used to upward reflect the light from the light source (26) allowing the light illuminating more efficiently. The upward guided light is applied to the bottoms of the keys (24) and irradiates upward through the light permitting portions of the keys (24), so that a user of the conventional illuminated keyboard is able to recognize keys (24) and operate the keyboard.

However, the reflected light from the light source (26) is not evenly distributed and resulted into unsatisfying illuminating effect. Furthermore, the necessity for the light guiding plate (25) and the optional reflecting plate (28) thickens the conventional keyboard. As a result, the conventional keyboard is facing a problem of not being favored in market under the tendency for compact and thin design.

To overcome the shortcomings, the present invention provides an illuminated keyboard module to mitigate or obviate the aforementioned problems.

### SUMMARY OF THE INVENTION

The main objective of the invention is to provide an illuminated keyboard module.

The illuminated keyboard module in accordance with the present invention has a base, a film circuit membrane, a illuminator membrane, multiple supporting frames, multiple keys and multiple illuminator. The film circuit membrane is attached onto the base. The illuminator membrane is attached onto the film circuit membrane and has multiple wires. The multiple supporting frames are attached onto the illuminator membrane and are connected to the base. Each key is attached onto the top of a supporting frame and has a light permitting portion. Each illuminator is attached to the illuminator membrane under a key and electrically connected to the wires. The illuminator irradiates lights going through the light permitting portions of one key to provide satisfying illuminating effect.

Other objectives, advantages and novel features of the invention will become more apparent from the following detailed description when taken in conjunction with the accompanying drawings.

### BRIEF DESCRIPTION OF THE DRAWINGS

FIG. 1 is an exploded perspective view of the base, film circuit membrane, the illuminator membrane of an illuminated keyboard module in accordance with the present invention;

FIG. 2 is a partial exploded perspective view of the illuminated keyboard module in FIG. 1;

FIG. 3 is a partial side view of the illuminated keyboard module in FIG. 1; and

FIG. 4 is a partially sectional side view of a conventional illuminated keyboard in accordance with the prior art.

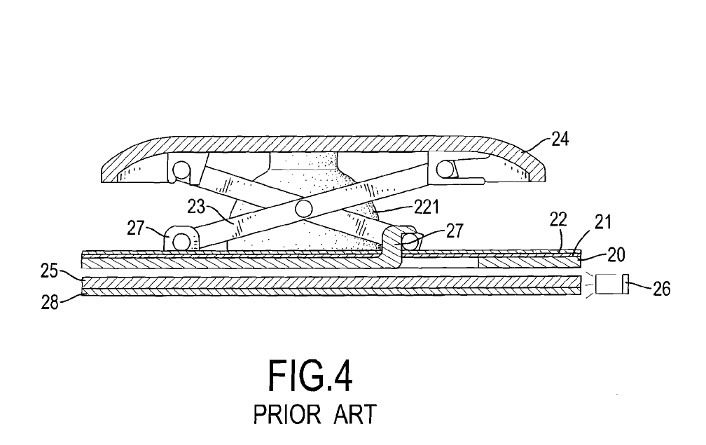

### DETAILED DESCRIPTION OF THE PREFERRED EMBODIMENTS

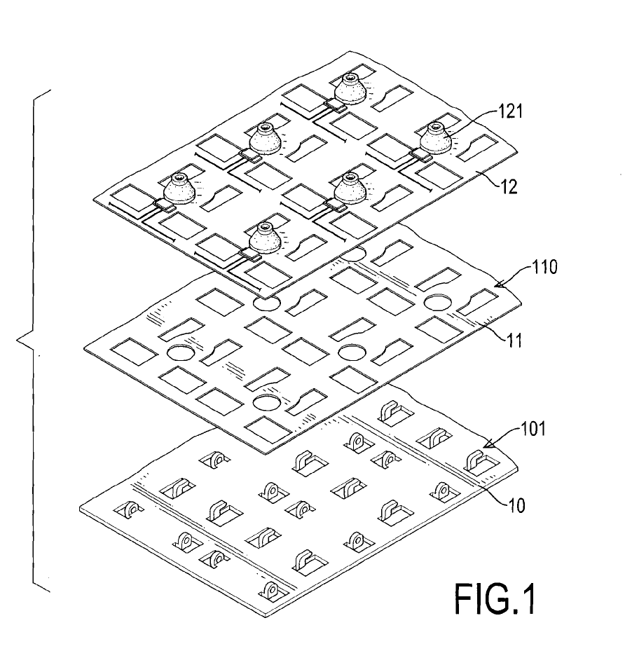

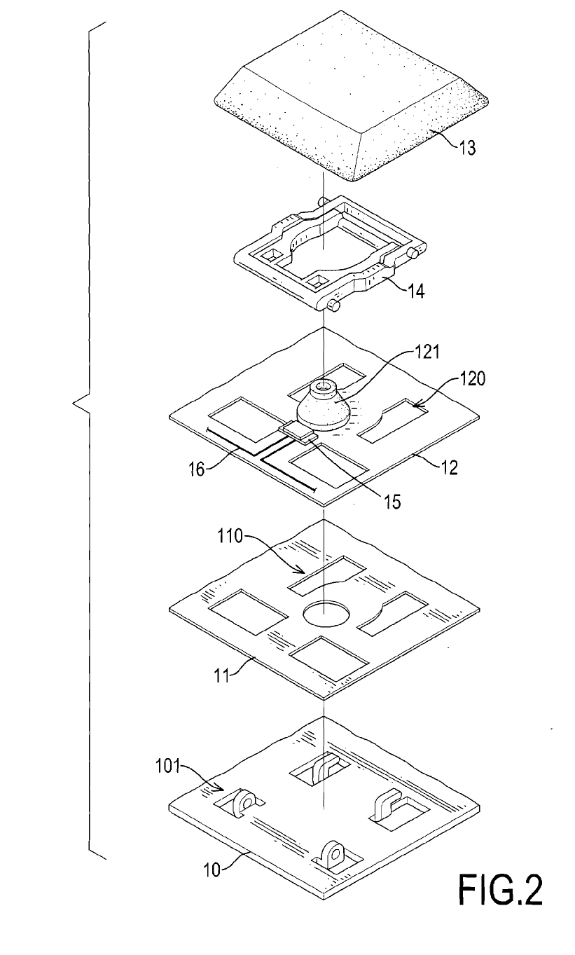

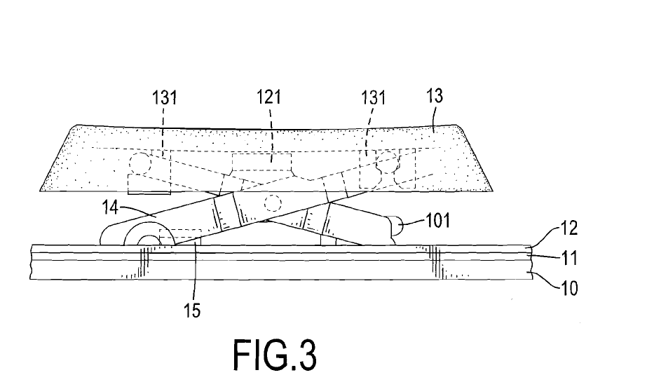

With reference to FIGS. 1 to 3, an illuminated keyboard module in accordance with the present invention comprises a base (10), a film circuit membrane (11), a illuminator membrane (12), multiple supporting frames (14), multiple keys (13) and multiple illuminators (15).

The base (10) may have multiple base connectors (101). Each base connector (101) has four connecting members. The connecting members may be two opposite rings and two opposite hooks. Each ring has a pivot hole defined through the pivot mount. The hooks are L-shaped.

The film circuit membrane (11) is used to deliver a signal generated when a key (13) is pressed. The film circuit membrane (11) is attached onto the base (10) and may have multiple fastening hole sets corresponding respectively to and receiving the base connectors (101). Each fastening hole set has four fastening holes (110) respectively mounted around the rings and hooks of a corresponding base connector (101).

The illuminator membrane (12) is attached onto the film circuit membrane (11) and has multiple pairs of wires (16). The multiple pairs of the wires (16) correspond respectively to the base connectors (101), are used to provide electrical energy for the multiple illuminators (15), wherein the electrical energy may be transferred from a circuit of a computer. The illuminator membrane (12) may have multiple through hole sets and multiple domes (121). The through hole sets correspond respectively to and receive the base connectors (101). Each through hole set has four through holes (120) respectively mounted around the rings and hooks of a corresponding base connector (120). The domes (121) are mounted on the illuminator membrane (12).

The multiple supporting frames (14) are constructed as pairs of scissors, correspond respectively to the base connector (101), are attached above the illuminator membrane (12) and each has a top and a bottom. When the base (10) has multiple base connectors (101), the bottoms of the multiple supporting frames (14) are connected pivotally to the multiple base connectors (101) respectively. The top of each supporting frame (14) has four mounting protrusions. The bottom of each supporting frame (14) has four mounting protrusions respectively engaged with the rings and hooks of a corresponding base connector (101).

The multiple keys (13) correspond respectively to the supporting frames (14), are respectively connected to the tops of the multiple supporting frames (14) and are located respectively above the domes (121). Each key (13) has a bottom and a light permitting portion and may have a key connector (13). The key connector (13) is formed on the bottom of the key (13), is connected to the top of a corresponding supporting frames (14) and has two opposite recesses and two opposite hooks. The recesses and hooks of the key connector (13) are engaged respectively with the mounting protrusions on the top of the corresponding supporting frame (14).

The multiple illuminators (15) are used as light sources for illuminating the keys (13). The multiple illuminators (15) are attached to the illuminator membrane (12) respectively under the keys (13), are electrically connected respectively to the pairs of wires (16) and maybe a light emitting diode (LED) chip. When the illuminator (15) illuminates the bottoms of the keys (13), a light is irradiated from the illuminator (15) goes through the light permitting portions of one key (13), providing satisfying illuminating effect while eliminating the necessity of a light guiding plate and a reflecting plate.

With the light irradiated from the illuminator (15) and going through the light permitting portions of one key (13), a keyboard module in accordance with the present invention would be able to provide satisfying illuminating effect without using a light guiding plate or a reflecting plate.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A illuminated keyboard module comprising
a base;
a film circuit membrane being attached onto the base;
a illuminator membrane being attached onto the film circuit membrane and having multiple pairs of wires;
multiple supporting frames being attached above the illuminator membrane, connected to the base and each having
a top; and
a bottom;
multiple keys being corresponding and connected respectively to the top of the supporting frames and having
a bottom; and
a light permitting portion; and
multiple illuminators being attached to the illuminator membrane respectively under the keys and electrically connected respectively to the pairs of the wires.

2. The illuminated keyboard module as claimed in claim 1, wherein
the illuminator is an LED chip.

3. The illuminated keyboard module as claimed in claim 1, wherein
the base has
multiple base connectors;
the film circuit membrane has
multiple fastening hole sets corresponding respectively to and receiving the base connectors;
the illuminator membrane further has
multiple through hole sets corresponding respectively to and receiving the base connectors; and
multiple domes mounted on the illuminator membrane and located respectively under the keys;
the bottoms of the multiple supporting frames are connected to the multiple base connectors respectively; and
each of the keys further has
a key connector being formed on the bottom of the key and being respectively connected to the top of a corresponding supporting frame.

4. The illuminated keyboard module as claimed in claim 2, wherein
the base has
multiple base connectors;
the film circuit membrane has
multiple fastening hole sets corresponding respectively to and receiving the base connectors;
the illuminator membrane further has
multiple through hole sets corresponding respectively to and receiving the base connectors; and
multiple domes mounted on the illuminator membrane and located respectively under the keys;
the bottoms of the multiple supporting frames are connected to the multiple base connectors respectively; and
each of the keys further has
a key connector being formed on the bottom of the key and being respectively connected to the top of a corresponding supporting frame.
